(19) United States
(12) Patent Application Publication
(10) Pub. No.: US 2025/0355502 A1
(43) Pub. Date: Nov. 20, 2025

(54) State Machine and Rejection Criterion for UI Gesture Invocation

(71) Applicant: Apple Inc., Cupertino, CA (US)

(72) Inventors: Chase B. Lortie, San Francisco, CA (US); Daniel J. Brewer, Redwood City, CA (US)

(21) Appl. No.: 19/202,618

(22) Filed: May 8, 2025

Related U.S. Application Data
(60) Provisional application No. 63/649,058, filed on May 17, 2024.

(51) Int. Cl. G06F 3/01; G06F 3/033

(52) U.S. Cl. CPC G06F 3/017; G06F 3/012; G06F 3/013; G06F 3/033

(57) ABSTRACT

Input gestures having a particular palm orientation are detected based on geometric characteristics of a hand relative to a head. Gaze information is used to determine a hand gesture state. The gesture state refers to a palm-up gesture or a palm-flip gesture. A hand orientation state machine is used to determine a hand orientation state based on the geometric characteristics. A gesture detection state machine is used to determine a hand gesture based on a hand orientation state and the gaze vector. An action is invoked based on the hand gesture state.

### BACKGROUND

Some devices can generate and present Extended Reality (XR) Environments. An XR environment may include a wholly or partially simulated environment that people sense and/or interact with via an electronic system. In XR, a subset of a person's physical motions, or representations thereof, are tracked, and in response, one or more characteristics of one or more virtual objects simulated in the XR environment are adjusted in a manner that comports with realistic properties. In some embodiments, a user may use gestures to interact with the virtual content. For example, users may use gestures to select content, initiate activities, or the like. However, what is needed is an improved technique to improve the determination of hand pose.

### BRIEF DESCRIPTION OF THE DRAWINGS

FIGS. 1A-1B show example diagrams of a user using a hand pose as an input pose, in accordance with one or more embodiments.

FIGS. 2A-2B example diagrams of a user using an alternate hand pose as an input pose, in accordance with one or more embodiments, in accordance with some embodiments.

FIG. 3 shows a flowchart of a technique for determining whether the hand is in an input pose, in accordance with some embodiments.

FIG. 4 shows a flowchart of a technique for determining relative characteristics of a hand and a head, in accordance with some embodiments.

FIG. 5 shows a hand orientation state machine for determining a palm position state, in accordance with one or more embodiments.

FIG. 6A shows a flowchart of a technique for determining whether a gaze criterion is satisfied, in accordance with one or more embodiments.

FIG. 6B shows a diagram of gaze targets, in accordance with one or more embodiments.

FIG. 7 shows a gesture detection state machine for determining a hand gesture state, in accordance with one or more embodiments.

FIG. 8 shows a state machine for activation and suppression of hand gestures, in accordance with one or more embodiments.

FIG. 9 shows a system diagram of an electronic device which can be used for gesture input, in accordance with one or more embodiments.

FIG. 10 shows an exemplary system for use in various extended reality technologies.

### DETAILED DESCRIPTION

This disclosure pertains to systems, methods, and computer readable media to enable gesture recognition and input. In some enhanced reality contexts, certain hand poses may be used as user input poses. For example, detection of a particular hand pose may trigger a particular user input action, or otherwise be used to allow a user to interact with an electronic device, or content produced by the electronic device. One classification of hand poses which may be used as user input poses may involve a hand being detected in a palm-up position. Another classification is a palm-flip gesture, where a hand is flipped from a palm-up position to a palm-down position. For example, a user may initiate presentation of an icon or other virtual content by holding their hand in a palm-up position. From this position, a user can flip their hand to activate additional or alternative virtual content by flipping their hand to a palm-down position.

According to one or more embodiments, determining whether a hand is in an input pose includes tracking not only the hand but additional joint location information for the user, such as a head position. In some embodiments, the location information may be determined based on sensor data from sensors capturing the various joints. Additionally, or alternatively, location information for the various joints may be inferred or otherwise derived from sensor data or a wearable device, such as a head mounted device. For example, a head position may be determined based on an offset distance and/or orientation from a headset position, or may use the headset position as the head position and/or orientation, in accordance with one or more embodiments.

In some embodiments, a hand may be determined to be in a palm-up position if the palm of the hand is mostly facing toward the head. This may be determined, for example, from camera data captured by a head-worn device or otherwise from the perspective of a user toward the user's hand. For example, a determination may be made as to whether the hand is mostly facing the camera or cameras. To that end, a spatial relationship may be determined between the hand and the head based on the sensor data or otherwise based on the location information. If the hand is determined to be sufficiently facing the head of the user, then the pose of the hand is classified as a palm-up input pose. Similarly, a hand may be determined to be in a palm-flip pose if, from the palm-up position, the hand is determined to be sufficiently facing away from the head or the camera. In addition, the hand may be determined to be in an invalid position if the hand is determined to be flexing, upside down, or the like.

In some embodiments, if a user is using a controller to interact with a user interface, the palm-up position and/or palm-flip pose may be defined based on an orientation of the controller with respect to the head of the user. To that end, the spatial relationship between the hand and the head may be determined based on a spatial relationship between data derived from hand tracking and a location and/or orientation of the head. Alternatively, the spatial relationship between the hand and the head may be based on a spatial relationship between an orientation of the controller and a location and/or orientation of the head. Thus, in some embodiments, the hand pose may be determined without respect to hand tracking data.

A hand gesture state may be determined by refining the hand pose determination based on gaze. For example, a hand may only be determined to be in a palm-up gesture or a palm-flip gesture if a gaze of the user is determined to satisfy a gaze criterion. The gaze criterion may be satisfied, for example, if a target of the gaze is within a threshold distance of a virtual object, or within a threshold distance of the hand. Alternatively, if the user is using a handheld controller to interact with the user interface, the gaze criterion may be satisfied if the target of the gaze is within a bounding box or other predefined geometry around a controller location based on controller tracking data. As such, if the hand pose transitions from an invalid pose to a palm-up pose, a palm-up gesture may only be determined if the gaze criterion is satisfied. Thus, by considering the hand pose along with the gaze, a gesture state may be determined.

According to some embodiments, the gesture determination may be revised based on one or more rejection reasons. For example, certain criteria may indicate that presentation of a virtual object should be blocked, or a current presentation of a virtual object should be dismissed. Further, some criteria may be used to determine whether to cancel an action associated with a gesture which may have been initiated.

Embodiments described herein provide an efficient manner for determining whether a user is performing an input gesture using only standard joint positions and other location information, and without requiring any additional specialized computer vision algorithms, thereby providing a less resource-intensive technique for determining an orientation of the palm. Further, embodiments described herein improve upon input gesture detection techniques by considering the pose of the hand along with gaze to further infer whether a detected gesture is intentional, thereby improving the usefulness and accuracy of gesture-based input systems.

In the following disclosure, a physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an XR environment refers to a wholly or partially simulated environment that people sense and/or interact with via an electronic device. For example, the XR environment may include Augmented Reality (AR) content, Mixed Reality (MR) content, Virtual Reality (VR) content, and/or the like. With an XR system, a subset of a person's physical motions, or representations are tracked, and in response, one or more characteristics of one or more virtual objects simulated in the XR environment, are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and adjust graphical content and an acoustic field presented to the person in a manner, similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include: head-mountable systems, projection-based systems, heads-up displays (HUD), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, or resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developer's specific goals (e.g., compliance with system-and business-related constraints) and that these goals may vary from one implementation to another. It will also be appreciated that such development efforts might be complex and time-consuming but would nevertheless be a routine undertaking for those of ordinary skill in the design and implementation of graphics modeling systems having the benefit of this disclosure.

For purposes of this application, the term “hand pose” refers to a position and/or orientation of a hand.

For purposes of this application, the term “input gesture” refers to a hand pose or motion which, when detected, triggers a user input action.

### Example Hand Poses

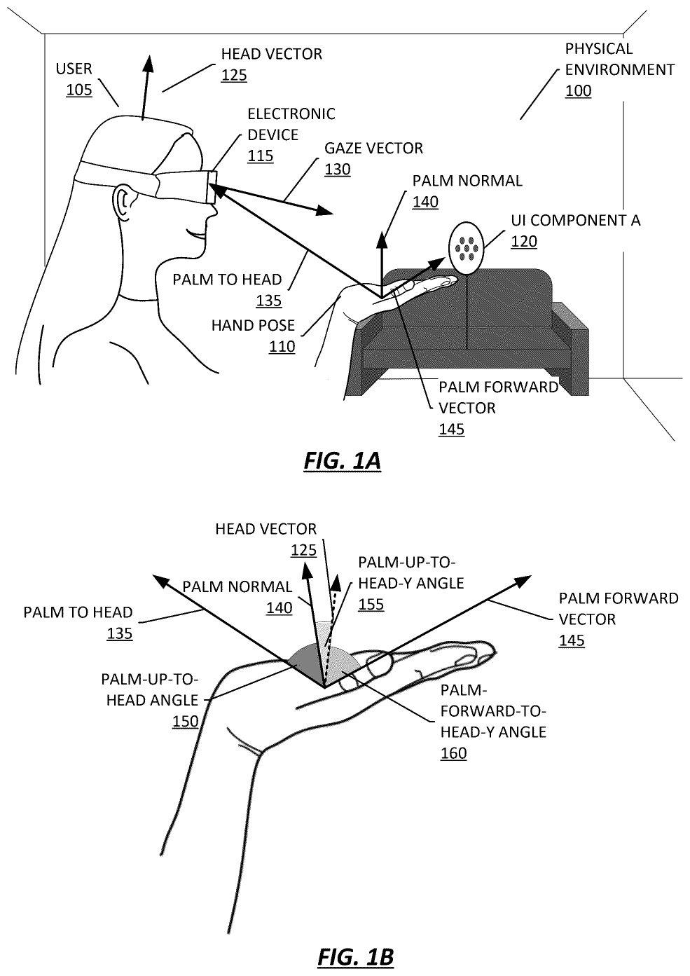

FIGS. 1A-1B show example diagrams of a user performing a first input gesture, in accordance with one or more embodiments. In particular, FIG. 1A shows a user 105 using an electronic device 115 within a physical environment 100. According to some embodiments, electronic device 115 may include a pass-through or see-through display such that components of the physical environment 100 are visible. In some embodiments, electronic device 115 may include one or more sensors configured to track the user to determine whether a pose of the user should be processed as user input. For example, electronic device 115 may include outward-facing sensors such as cameras, depth sensors, and the like which may capture one or more portions of the user, such as hands, arms, shoulders, and the like. Further, in some embodiments, the electronic device 115 may include inward-facing sensors, such as eye tracking cameras, which may be used in conjunction with the outward-facing sensors to determine whether a user input gesture is performed.

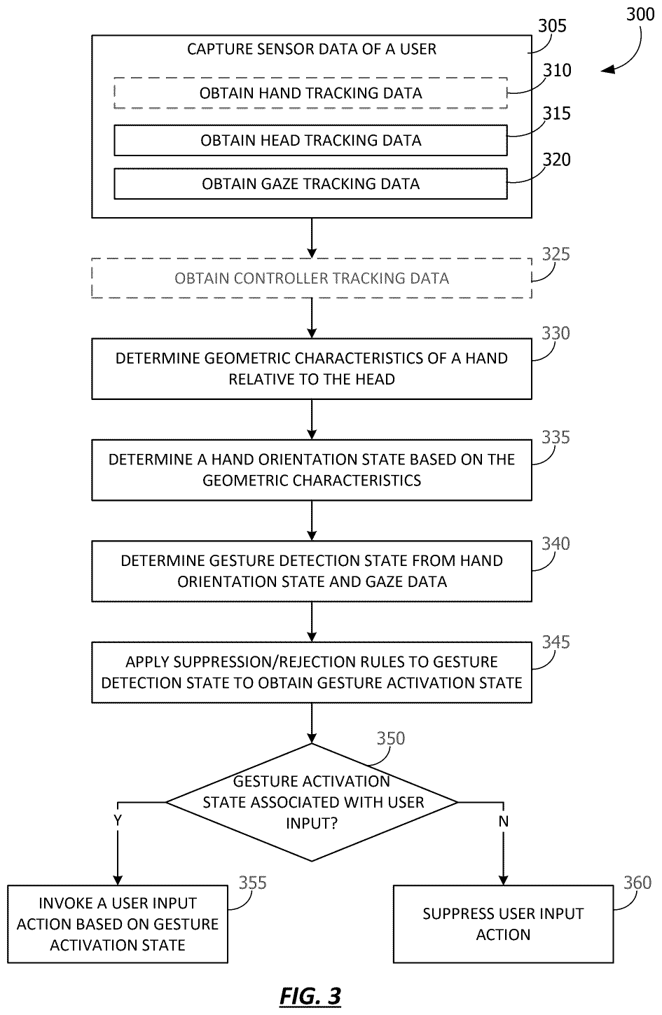

Certain hand positions or gestures may be associated with user input actions. In the example shown, user 105 has their hand in hand pose 110, in a palm-up position. For purposes of the example, the palm-up position may be associated with a user input action to cause user interface (UI) component A 120 to be presented. According to one or more embodiments, UI component A 120 may be virtual content which is not actually present in physical environment 100, but is presented by electronic device 115 and an extended reality context such that UI component A 120 appears within physical environment 100 from the perspective of user 105. Virtual content may include, for example, graphical content, image data, or other content for presentation to a user. In some embodiments, the hand pose 110 may be determined to be a palm-up input pose based on a relative position of the hand to the head. For example, if the hand is facing the head more than it is facing away from the head, the hand may be determined to be in a palm-up position. Various techniques may be used to determine whether the hand is in a palm-up position, as will be described below in greater detail with respect to FIGS. 3-9.

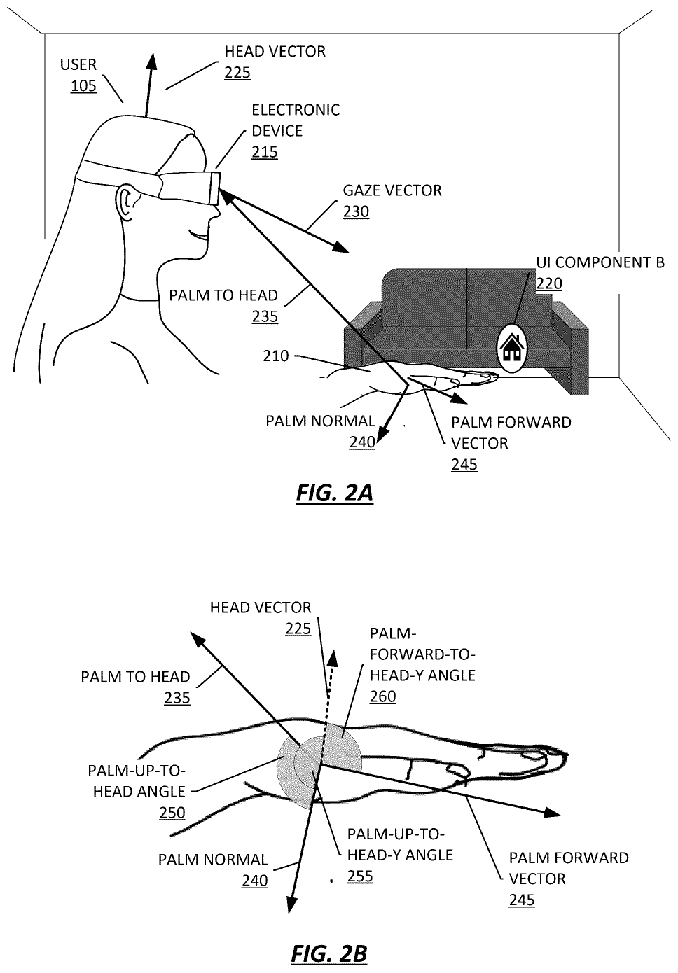

FIG. 2A depicts an alternate example of a user input component. In particular, in FIG. 2A, user 105 has changed their hand position, such that the palm is now facing down. In particular, hand pose 210 shows the palm facing a floor of the physical environment. According to some embodiments, determination that the hand is in a palm down position maybe associated with a user input action that differ from the palm-up pose shown in FIG. 1A. Further, detection of a palm down position may be indicative of a palm-flip gesture. For example, when a user is in a palm-up input gesture position, as shown at FIG. 1A, and the user flips their hand so the palm is in a palm down position, the gesture maybe associated with the particular user input action. Here, the hand pose 210 is associated with presentation of UI component B 220. According to one or more embodiments, UI component B 220 may be virtual content which is not actually present in physical environment 100, but is presented by electronic device 115 and an extended reality context such that UI component A 120 appears within physical environment 100 from the perspective of user 105.

### User Interface Gesture Invocation Overview

Turning to FIG. 3, shows a flowchart of a technique for determining whether the hand is in an input pose, in accordance with some embodiments. For purposes of explanation, the following steps will be described as being performed by particular components. However, it should be understood that the various actions may be performed by alternate components. The various actions may be performed in a different order. Further, some actions may be performed simultaneously, and some may not be required, or others may be added.

The flowchart 300 begins at block 305, tracking data is captured of a user. According to some embodiments, tracking data is obtained from sensors on an electronic device, such as cameras, depth sensors, or the like. The tracking data may include, for example, image data, depth data, and the like, from which pose, position, and/or motion can be estimated. For example, location information for one or more joints of a hand can be determined from the tracking data, and used to estimate a pose of the hand. According to one or more embodiments, the tracking data may include position information, orientation information, and/or motion information for different portions of the user.

In some embodiments, the tracking data may include or be based on additional sensor data, such as image data and/or depth data captured of a user's hand or hands in the case of hand tracking data, as shown at optional block 310. In some embodiments, the sensor data may be captured from sensors on an electronic device, such as outward-facing cameras on a head mounted device, or cameras otherwise configured in an electronic device to capture sensor data including a user's hands. Capturing sensor data may also include, at block 315, obtaining head tracking data. In some embodiments, the sensor data may include position and/or orientation information for the electronic device from which location or motion information for the user can be determined. According to some embodiments, a position and/or orientation of the user's head may be derived from the position and/or orientation data of the electronic device when the device is worn on the head, such as with a headset, glasses, or other head mounted device.

In some embodiments, capturing tracking data of a user may additionally include obtaining gaze tracking data, as shown at block 320. Gaze may be detected, for example, from sensor data from eye tracking cameras or other sensors on the device. For example, a head mounted device may include inward-facing sensors configured to capture sensor data of a user's eye or eyes, or regions of the face around the eyes which may be used to determine gaze. For example, a direction the user is looking may be determined in the form of a gaze vector. The gaze vector may be projected into a scene that includes physical and virtual content.

As shown at optional block 325, the flowchart 300 may also include obtaining controller tracking data. In some embodiments, controller tracking data may include sensor data, such as image data and/or depth data captured of a controller held by the user. In some embodiments, the controller tracking data may include a location of the controller, which may include one or more representative points in space, a representative geometry, or the like, representing a location of the controller. The controller tracking data may, optionally, include additional information derived from the sensor data, such as an orientation of the controller or the like.

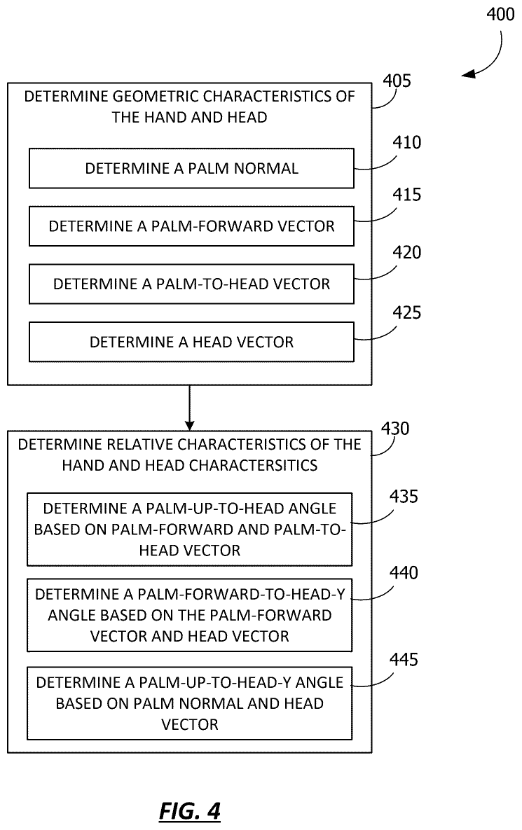

The flowchart 300 proceeds to block 325, where geometric characteristics for the hand relative to the hand are calculated or otherwise determined. In some embodiments, the geometric characteristics may include a relative position and/or orientation of the hand (or point in space representative of the hand and/or controller) and the head (or point in space representative of the head). In some embodiments, the geometric characteristics may include various vectors determined based on the location information for various portions of the user. Example parameters and other metrics relating to the geometric characteristics will be determined in greater detail below with respect to FIG. 4.

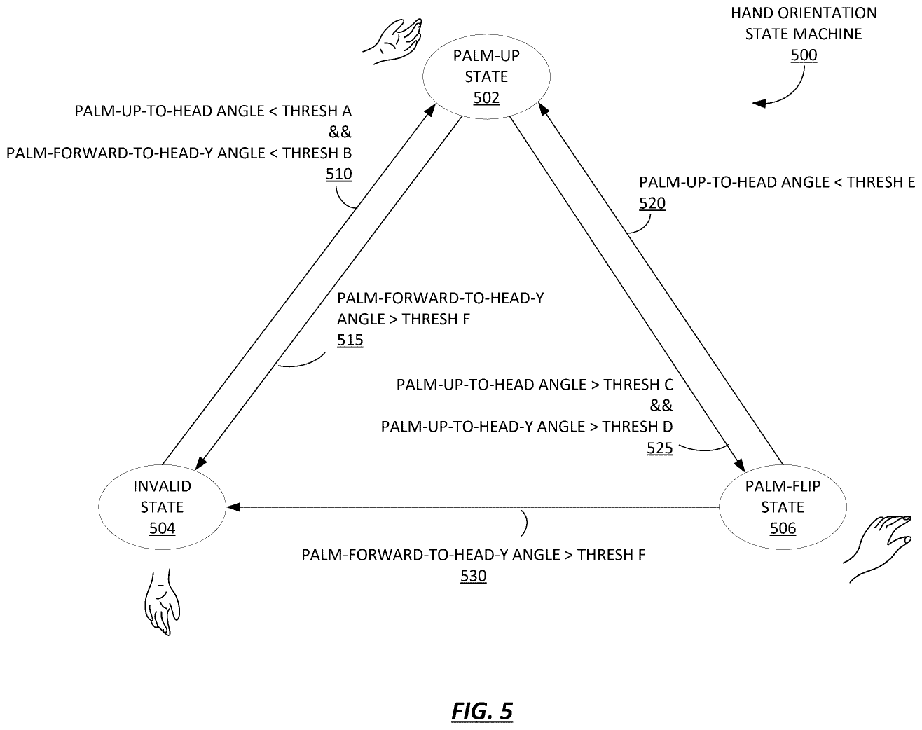

At block 330, a hand orientation state is determined based on the geometric characteristics. According to one or more embodiments, the hand orientation state may indicate a pose and/or position of the hand and/or controller in a particular frame. In some embodiments, the hand pose may be determined using various metrics of the geometric characteristics of the hand relative to the hand. For example, position and/or orientation information for a palm and a head, and/or relative positioning of the palm and the head may be used to determine whether a palm is mostly facing toward the head or camera, thereby being in a palm-up orientation state, or whether the palm is mostly facing away from the head, thereby being in a palm-down orientation state. In embodiments in which a user is holding a controller, position and/or orientation information for the controller and a head, and/or relative positioning of the controller and the head may be used to determine whether the controller satisfies a palm-up orientation state, palm-down orientation state, or the like. In some embodiments, a hand orientation state machine may be used to determine a hand orientation state, as will be described in greater detail below with respect to FIG. 5.

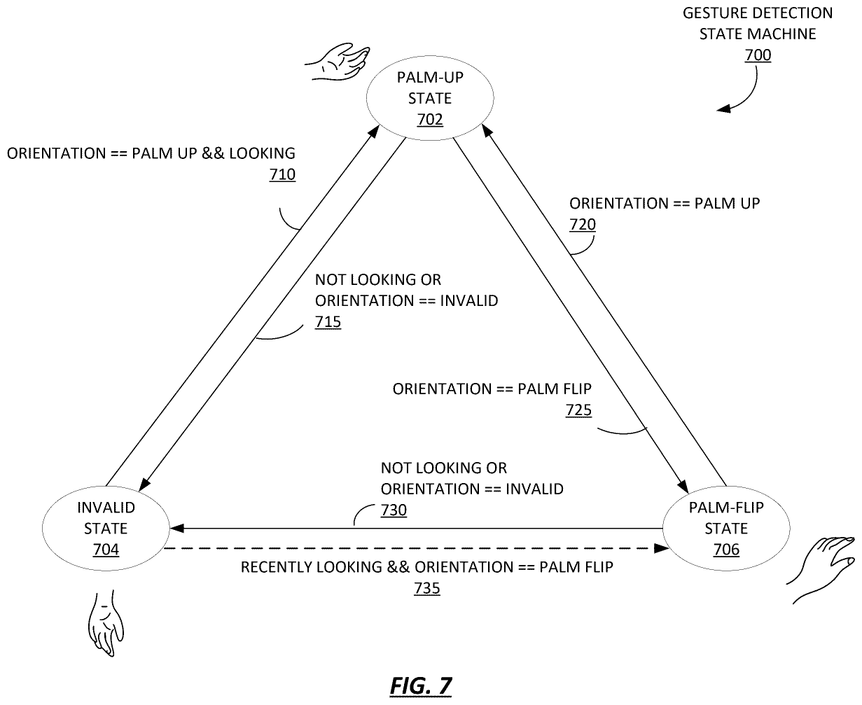

The flowchart 300 proceeds to block 335, where a gesture detection state is determined based on the hand orientation state and gaze information. According to some embodiments, the gesture detection state may differ from a hand orientation state by using geometric characteristics to infer intentionality of a hand orientation to indicate a gesture. For example, a hand having a hand orientation state of palm up may not be detected as a palm up gesture if other geometric characteristics indicate the hand orientation is not intended to be an input gesture. As an example, hand orientations that correspond to input gestures may be ignored when a user's gaze indicates that the hand orientation is not intended to be an input gesture. In some embodiments, a gaze target may be considered to determine if a gaze criterion is satisfied. A gaze criterion may be satisfied, for example, if a user is looking at the hand performing the pose, or a point in space within a region where virtual content associated with the user input action is currently presented, or where the virtual content would be presented. In embodiments in which a user is using a controller, the gaze criterion may be satisfied, for example, if a user is looking at the controller, which may be determined, for example, if a target of the user's gaze is within a predefined geometry surrounding the controller location. In some embodiments, a gesture detection state machine may be used to determine a gesture detection state, as will be described in greater detail below with respect to FIG. 7.

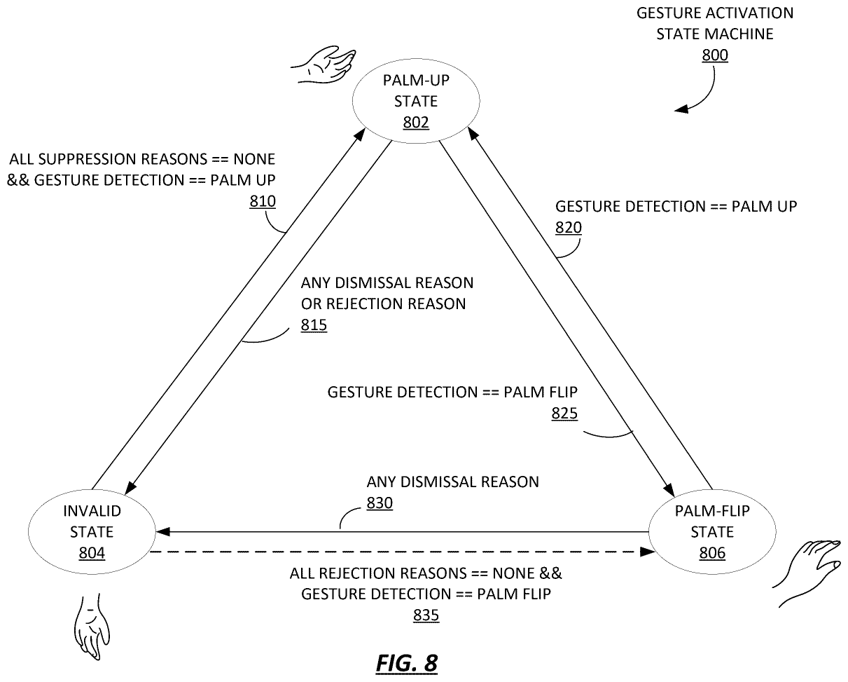

At block 340, suppression and/or rejection rules may be applied to the gesture detection state to obtain a gesture activation state. The gesture activation state may indicate a state of a hand gesture which may trigger a user input action. The gesture activation state may differ from the gesture detection state in that the gesture detection state indicates a gesture that is detected, whereas the gesture activation state indicates the gesture that should be used for user input, and is based on the gesture detection state. Examples of suppression and/or rejection rules or criteria may be based on characteristics of the hand, head, gaze, or the like which, when satisfied, indicate that the hand gesture should be ignored and/or the associated input action should be modified. For example, a UI component or other virtual content may be blocked from being revealed, a UI component or other virtual content may be dismissed, or an active input action may be cancelled. Examples of rejection reasons may include, for example, hand motion, wrist motion, occlusion, relative distance of hand to head, predefined hand poses which should be rejected, and the like. In some embodiments, a gesture activation state machine may be used to determine a gesture activation state, as will be described in greater detail below with respect to FIG. 8.

The flowchart 300 proceeds to block 345, where a determination is made as to whether the gesture activation state is associated with user input. For example, the gesture activation state may be selected from one or more valid input gestures and an invalid state. Examples of valid input gestures include, for example, a palm-up input gesture and a palm-flip input gesture, as described above with respect to FIGS. 1A and 2A. If a determination is made that the gesture activation state is associated with user input (for example, if the gesture activation state aligns with a valid input gesture), then the flowchart concludes at block 350, and a user input action is invoked based on the gesture activation state. For example, if hand pose 110 of FIG. 1A is determined to correspond to a valid palm-up gesture activation state based on palm position and gaze direction, then UI component A 120 will be presented. Similarly, if hand pose 210 of FIG. 2A is determined to correspond to a valid palm-flip gesture activation state, then UI component B 220 will be presented.

Returning to block 345, if a determination is made that the gesture activation state is not associated with user input (for example, if the gesture activation state is determined to be invalid), then the flowchart concludes at block 355, and a user input action is suppressed. For example, a UI component associated with the gesture may not be presented. According to one or more embodiments, one or more corrective actions may be taken. As an example, a previously activated input action may be cancelled, or a currently presented UI component may be dismissed.

According to embodiments described herein, an input pose may be identified based on various spatial relationships between a hand and a head of a user. FIG. 4 shows a flowchart of a technique for determining some relative characteristics of a hand and a head, in accordance with some embodiments. For purposes of explanation, the following steps will be described as being performed by particular components and with respect to the examples shown in FIGS. 1A-1B. However, it should be understood that the various actions may be performed by alternate components. The various actions may be performed in a different order. Further, some actions may be performed simultaneously, and some may not be required, or others may be added.

The flowchart 400 begins at block 405, where geometric characteristics of the hand and head are determined. The geometric characteristics may include, for example, position and/or orientation information for the hand and the head. This may include, as shown at block 410, a palm normal determination. According to one or more embodiments, the palm normal may be defined by a vector from a central representative point of the palm and facing away from the palm. Turning to FIG. 1A, palm normal 140 is shown in an upward direction. By contrast, turning to FIG. 2A, palm normal 240 is shown in a downward direction.

Determining geometric characteristics of the hand and head may additionally include, at block 415, determining a palm-forward vector. The palm-forward vector may be a directional vector indicating a pointing direction of the palm. This may be determined, for example, based on a directional vector originating at a wrist and extending through an index knuckle or other joint or representative location on an upper portion of the palm. As shown in FIG. 1A, palm-forward vector 145 is shown pointing slightly upward, whereas in FIG. 2A, palm-forward vector 245 is pointing slightly downward.

Determining geometric characteristics of the hand and head may additionally include, at block 420, determining a palm-to-head vector. The palm-to-head vector may indicate a directional vector from an origin location of the palm towards a gaze origin, such as a representative head location, head mounted device location, eye location, or the like. As shown in FIG. 1A, palm-to-head vector 135 is shown from the palm to eye region, and is similar to palm-to-head vector 235 of FIG. 2A.

Determining geometric characteristics of the hand and head may additionally include, at block 425, determining a head vector. The head vector may indicate a directional vector from a head location or representative head location, such as a head mounted device location, eye location, or the like, and in an upward direction from the perspective of the head and/or headset, for example in a “y” direction. That is, the head vector may change direction as the head tilts. As shown in FIG. 1A, head vector 225 is shown extending from the head of user 105, and is similar to head vector 225 of FIG. 2A.

The various geometric characteristics may be used to determine other spatial relationships among the hand and the head. The flowchart thus proceeds to block 430, where relative characteristics of the hand and head are determined. The relative characteristics of the hand and head may be based on measurements between different geometric characteristics, as described above with respect to block 405.

According to one or more embodiments, determining relative characteristics of the hand and head may include, as shown at block 435, determining a palm-up-to-head angle based on the palm-forward vector and the palm-to-head vector. According to one or more embodiments, the palm-up-to-head angle may indicate how much a hand is facing the user's eyes, cameras of the device, or the like. Said another way, the palm-up-to-head angle may indicate relative characteristics of the hand and head which indicate a relative direction of the palm to the head, or a representative location for the head such as gaze origin, head mounted device location, or the like. Turning to FIG. 1B, palm-up-to-head angle 150 is shown as the angle between the palm-to-head vector 135 and the palm normal 140. Similarly, as shown at FIG. 2B, the palm-up-to-head angle 250 shows an angle between palm normal 240 and palm-to-head vector 235.

According to one or more embodiments, determining relative characteristics of the hand and head may include, as shown at block 440, determining a palm-forward-to-head-y angle based on the palm-forward vector and the head vector. According to one or more embodiments, the palm-forward-to-head-y angle may indicate flexed or pointed the hand is. Said another way, the palm-forward-to-head-y angle may indicate when a hand is performing an extreme flexing action or other pose which may be used for blocking or cancelling user input. Turning to FIG. 1B, palm-forward-to-head-y angle 160 is shown as the angle between the head vector 125 (which has been transposed from the determination location originating from the user's head in FIG. 1A) and the palm-forward vector 145. Similarly, as shown at FIG. 2B, the palm-forward-to-head-y angle 260 shows an angle between palm-forward vector 245 and head vector 225.

According to one or more embodiments, determining relative characteristics of the hand and head may include, as shown at block 445, determining a palm-up-to-head-y angle based on the palm normal vector and the head vector. According to one or more embodiments, the palm-up-to-head-y angle may indicate how much a palm is facing upward. Turning to FIG. 1B, palm-up-to-head-y angle 155 is shown as the angle between the head vector 125 (which has been transposed from the determination location originating from the user's head in FIG. 1A) and the palm normal 140. Similarly, as shown at FIG. 2B, the palm-up-to-head-y angle 255 shows an angle between palm normal 240 and head vector 225.

### Hand Orientation State Determination

According to one or more embodiments, the various parameters related to the geometric characteristics can be used in conjunction to determine whether to allow a user input gesture. In some embodiments, one or more state machines are used to determine whether to allow a user input gesture. FIG. 5 shows a hand orientation state machine for determining a palm position state, in accordance with one or more embodiments.

According to one or more embodiments, the hand orientation state machine 500 is configured to perform a preliminary check for a hand orientation state based on the various geometric parameters. In some embodiments, the candidate hand orientation states may include a palm-up state 502, a palm-flip state 506, and an invalid state 504, where the hand pose is neither in a palm-up state or a palm-flip state. According to one or more embodiments, the hand orientation state may begin with a hand orientation state based on hand pose.

According to one or more embodiments, the hand orientation state may transition from an invalid state 504 to a palm-up state 502 based on the palm-up-to-head angle, as shown at 510.). If the palm-up-to-head angle is less than the first threshold angle, and the palm-forward-to-head-y angle is less than the second threshold angle, the hand orientation state may transition from the invalid state 504 to the palm-up state 502. From an invalid state 504, a hand orientation state may transition to a palm-up state 502, as shown at 510. However, in some embodiments, a hand orientation state may not transition to a palm-flip state 506 from an invalid state 504. Said another way, to transition from an invalid state 504 to a palm-up state 502, the palm normal vector, palm-forward vector, a palm-to-head vector, and/or a head vector may be considered. In some embodiments, a palm-up-to-head angle is considered, indicating a metric for how much the hand is facing the eyes, head, or camera. Further, the palm-forward-to-head-y angle may be considered, indicating how flexed or pointed down the hand is. In some embodiments, the palm-up-to-head angle is compared to a first threshold angle, and the palm-forward-to-head-y angle is compared to a second threshold angle (which may be the same or different value than the first threshold angle

As an example, returning to FIG. 1B, the palm-up-to-head angle 150 and the palm-forward-to-head-y angle 160 are both below 45 degrees while the hand is in a palm-up position. By contrast, turning to FIG. 2B, the palm-up-to-head angle 250 and the palm-forward-to-head-y angle 260 are both at least 90 degrees. Thus, the palm position in FIG. 1 is likely to show the palm-up-to-head angle 150 and the palm-forward-to-head-y angle 160 satisfying the threshold values at 510 of hand orientation state machine 500.

Alternatively, a hand orientation state may transition from a palm-up state 502 to an invalid state 504 based on a palm-forward-to-head-y angle being greater than a threshold, as shown at 515. Similarly, a hand orientation state may transition from a palm-flip state 506 to an invalid state 504 based on a palm-forward-to-head-y angle being greater than a threshold, as shown at 530. This may occur, for example, based on a pointing direction of a hand, such as when a hand is pointing downward, either because the hand is flexing or because the hand is upside down. Said another way, to transition to an invalid state 504, the palm-forward vector and/or the head vector may be considered.

As an example, returning to FIG. 1B, the palm-forward-to-head-y angle 160 is approximately 45 degrees while the hand is in a palm-up position. By contrast, turning to FIG. 2B, the palm-forward-to-head-y angle 260 is around 80 degrees. Thus, the palm position in both FIG. 1 and FIG. 2 are likely to show the palm-forward-to-head-y angle satisfying the threshold values at 530 of hand orientation state machine 500.

According to one or more embodiments, the hand orientation state may transition from a palm-up state 502 to a palm-flip state 506 based on the palm-up-to-head angle and palm-up-to-head-y angle, as shown at 525. Said another way, to transition from a palm-up state 502 to a palm-flip state 506, the palm normal vector, the palm-to-head vector, and/or a head vector may be considered. In some embodiments, a palm-up-to-head angle is considered, indicating a metric for how much the hand is facing the eyes, head, or camera. Further, the palm-up-to-head-y angle may be considered, indicating how much the palm normal is facing up. In some embodiments, the palm-up-to-head angle is compared to a first threshold angle, and the palm-forward-to-head-y angle is compared to a second threshold angle (which may be the same or different value than the first threshold angle). Further, each threshold value may be the same or differ from the threshold values considered at steps 510, 515, and 530. If the palm-up-to-head angle is greater than the first threshold angle, and the palm-up-to-head-y angle is greater than the second threshold angle, the hand orientation state may transition from the palm-up state 502 to the palm-flip state 506.

As an example, returning to FIG. 1B, the palm-up-to-head angle 150 and the palm-up-to-head-y angle 155 are both below 30 degrees while the hand is in a palm-up position. By contrast, turning to FIG. 2B, the palm-up-to-head-y angle 155 and the palm-up-to-head angle 250 are both at least 100 degrees. Thus, the palm position in FIG. 2B is likely to show the palm-up-to-head angle 250 and the palm-up-to-head-y angle 255 satisfying the threshold values at 525 of hand orientation state machine 500.

Finally, the hand orientation state may transition from a palm-flip state 506 to a palm-up state 502 based on the palm-up-to-head angle, as shown at block 520. Said another way, to transition from a palm-flip state 506 to a palm-up state 502, the palm normal vector and/or the palm-to-head vector may be considered. In some embodiments, a palm-up-to-head angle is considered, indicating a metric for how much the hand is facing the eyes, head, or camera. In some embodiments, the palm-up-to-head angle is compared to a threshold angle, which may be the same or different than other threshold values used in hand orientation state machine 500. If the palm-up-to-head angle is less than the threshold angle, the hand orientation state may transition from the palm-flip state 506 to the palm-up state 502.

As an example, returning to FIG. 1B, the palm-up-to-head angle 150 is less than 30 degrees while the hand is in a palm-up position. By contrast, turning to FIG. 2B, the palm-up-to-head angle 250 is at least 100 degrees. Thus, the palm position in FIG. 1 is likely to show the palm-up-to-head angle 255 satisfying the threshold values at 520 of hand orientation state machine 500.

### Gesture Detection State Determination

According to one or more embodiments, while hand orientation state is determined irrespective of gaze, a gaze vector may be considered in determining a gesture detection state. In particular, a gaze vector may be identified and used to determine whether a gaze criterion is satisfied. Generally, a gaze criterion may be satisfied if a target of the gaze is directed to a region of interest, such as a region around a hand performing a gesture, or a portion of the environment displaying a virtual component, or where a virtual component is to be displayed.

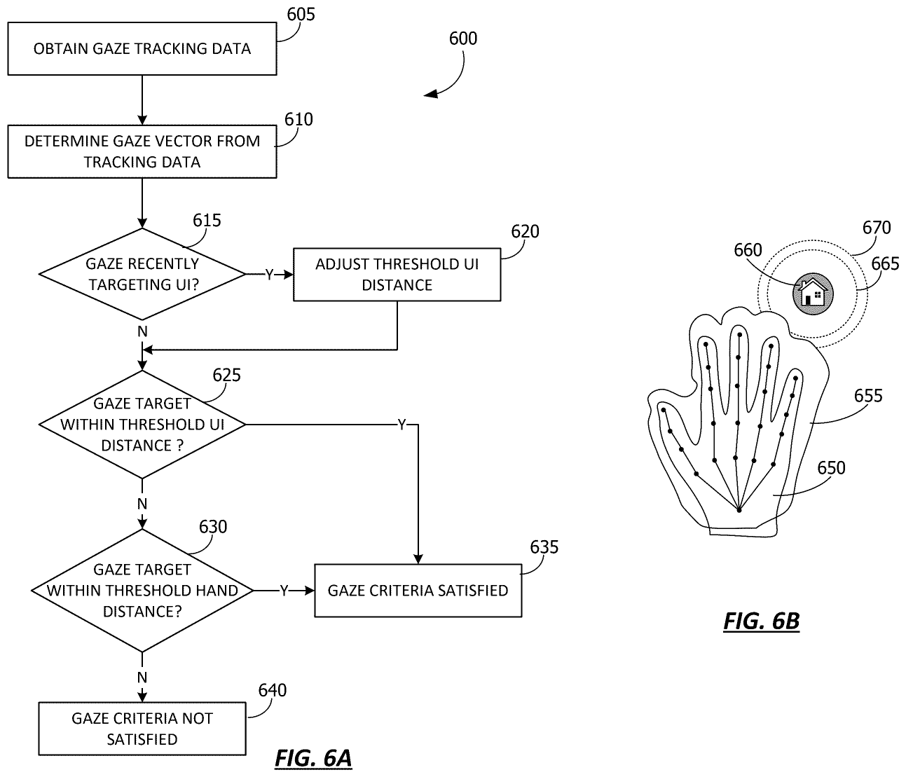

FIG. 6A shows a flowchart of a technique for determining whether a gaze criterion is satisfied, in accordance with one or more embodiments. For purposes of explanation, the following steps will be described as being performed by particular components. However, it should be understood that the various actions may be performed by alternate components. The various actions may be performed in a different order. Further, some actions may be performed simultaneously, and some may not be required, or others may be added.

The flowchart 600 begins at block 605, where gaze tracking data is obtained. For example, an eye tracking system may include one or more sensor is configured to capture image data or other sensor data from which the viewing direction of eye can be determined. The flowchart 600 proceeds to block 610, where a gaze vector is obtained from gaze tracking data. According to one or more embodiments, the gaze vector may be obtained from gaze tracking data, such as inward facing cameras on a head mounted device or other electronic device facing the user. A gaze tracking system may include one or more sensors configured to capture image data or other sensor data from which the viewing direction of eye can be determined.

At block 615, a determination is made as to whether a gaze was recently targeting a user interface component, or a region reserved for the user interface component. This may occur, for example, when a most recent instance of a gaze vector intersecting a UI component region occurred within a threshold time period, such as if a user momentarily looked away. A gaze target is determined from the gaze vector. For example, returning to FIG. 1A, gaze vector 130 is shown originating at the electronic device 115, or an eye position behind electronic device 115, and pointing toward UI component A 120. Similarly, in FIG. 2A, gaze vector 230 is directed toward UI component B 220. In some embodiments, the gaze target may be a point in space relative to physical and/or virtual content in an extended reality environment. Within the threshold time period, the flowchart proceeds to block 620, and the threshold UI distance is adjusted. For example, if a user looks away, a UI region may be narrowed such that the gaze make criteria becomes stricter. In the example shown in FIG. 6B, a target region may be associated with UI component 660. The target region may surround the UI component 660, and/or may be based on the location where the UI component is to be presented, such as an anchor position for the UI component. This may occur, for example, if the UI component is to be presented based on a location of another component in the environment, such as the fingertips of the hand, a physical object in the environment, or the like. The target region around the UI component may shrink from region 670 to region 665 during the time period.

After the threshold UI distance is adjusted at block 620, or if a determination was made at block 615 that the gaze was not recently targeting the UI component, then the flowchart 600 proceeds to block 625 and a determination is made as to whether the gaze target is within the threshold UI distance. As shown in FIG. 6B, the threshold UI distance may either within region 665 or region 670, depending upon whether the threshold UI distance was adjusted at block 620. If a determination is made that the gaze target is within a current threshold UI distance of the UI component, then the flowchart concludes at block 635, and the gaze criteria is considered to be satisfied.

Returning to block 625, if a determination is made that the gaze target is not within the threshold UI distance, then the flowchart 600 proceeds to block 630, where a determination is made as to whether the gaze target is within a threshold hand distance. With respect to the hand 650, the hand region 655 may be determined in a number of ways. For example, a geometry of the hand or around the hand may be determined in the image data, and may be compared against a gaze vector. As another example, a skeleton of the hand may be obtained using hand tracking data, and a determination may be made as to whether the gaze falls within a threshold location of the skeleton components for which location information is known. As an example, the hand region 655 may be defined as a region comprised of a bone length distance around each joint location, creating a bubble shape. If a determination is made that the gaze target is within the threshold hand distance, then the flowchart concludes at block 635, and the gaze criterion is determined to be satisfied. However, if a determination is made at block 630 that the gaze target is not within a threshold hand distance, such as hand region 655, the flowchart concludes at block 640 and the gaze criteria is determined to not be satisfied.

In some embodiments, additional considerations may be applied to determine whether a gaze criterion is satisfied. In some embodiments, a debounce parameter may be applied. For example, a gaze signal may be required to stabilize before the gaze criterion is considered to be satisfied or not satisfied. A debounce time period may be applied to the determination of whether the gaze criterion is or is not satisfied. In some embodiments, the debounce time period may be different for determining whether a gaze criterion is satisfied, than when determining that a gaze criterion is no longer satisfied. Further, in some embodiments, the debounce time period(s) may be adjusted based on gaze. For example, if a user looks away significantly (i.e., past a threshold gaze angle or distance), then the debounce time may be reduced.

A hand gesture state may be determined based on the gaze status, such as whether a gaze criterion is satisfied, and a hand orientation state. FIG. 7 shows a gesture detection state machine for determining a gesture detection state, in accordance with one or more embodiments. As described above, the gaze criterion may be determined to be satisfied if the user is looking at or near a hand or a UI component (or, in some embodiments, a region at which a UI component is to be presented). To that end, the gesture detection state machine 700 indicates that the gaze criterion is satisfied by the term “LOOKING,” and indicates that the gaze criterion is not satisfied by the term “NOT LOOKING,” for purposes of clarity. In some embodiments, the candidate hand gesture states may include a palm-up state 702, a palm-flip state 706, and an invalid state 704, where the gesture is neither in a palm-up state or a palm-flip state. Accordingly, in some embodiments, the gesture detection states may be considered a refined state from the hand orientation state as described above with respect to FIG. 5, once gaze is taken into consideration. Said another way, the gesture detection state may be an extension from the hand orientation state. To that end, the gesture detection state machine 700 may begin from a state determined from the hand orientation state machine 500 of FIG. 5. In some embodiments, the hand orientation state may be determined using other techniques, such as if the user is holding a controller, and an orientation of the controller with respect to the head determines the hand orientation state.

According to one or more embodiments, the gesture detection state may transition from a palm-up state 702 to a palm-flip state 706 based on the hand pose determined to be in a palm-flip state, as shown at 725, without respect to gaze. Thus, in some embodiments, the gaze may not be considered in transitioning a gesture from a palm-up state to a palm-flip state. Similarly, at 720, a palm-flip state 706 may transition to a palm-up state 702 based on the hand orientation state being a palm-up state. Said another way, transitions between the palm-up state and palm-flip state may be based on characteristics of the head and hand, such as the palm normal vector, the palm-to-head vector, and/or a head vector, and without regard for a gaze vector. To that end, the gesture detection state may mirror the hand orientation state with respect to transitions between palm-up and palm-flip. In some embodiments, gaze may be considered. For example, gaze may be required to be directed toward the hand or UI component region to determine a state change. If the gaze target moves away from the UI component, then the UI may be dismissed and the UI may need to be re-engaged by looking at the hand.

From a palm-flip state 706, the gesture detection state may transition to an invalid state 704 based on gaze and pose orientation state, as shown at 730. In some embodiments, the gesture detection state may transition from the palm-flip state 706 to an invalid state 704 if a gaze criterion is not satisfied, or if a pose is invalid. Similarly, the gesture detection state may transition from the palm-up state 702 to an invalid state 704 if a gaze criterion is not satisfied, or if a pose is invalid, as shown at 715. Said another way, if the hand orientation state indicated an invalid pose, then the gesture detection state will also be invalid. However, in some embodiments, the hand gesture state may also transition to invalid if, from a palm-flip state 706 or a palm-up state 702, a gaze criterion is not satisfied.

From the invalid state 704, the gesture detection state may transition to the palm-up state 702 if the hand orientation state is a palm-up state, and if the gaze criterion is satisfied, as shown at 710. For example, if from the invalid state, where the hand has been upside down or otherwise pointing downward, a hand orientation state is determined to be in a palm-up state, the gesture detection state will only transition to the palm-up state 702 if the gaze criterion is satisfied.

According to one or more embodiments, the hand gesture state may not support a transition from an invalid state 704 to a palm-flip state 706. However, in some embodiments, the gesture detection state machine 700 may optionally support a transition from invalid state 704 to palm-flip state 706. For example, as shown at 735, the hand gesture state may transition from invalid state 704 to palm-flip state 706 if the hand orientation state is determined to be the palm-flip state, and the gaze is determined to have recently satisfied the gaze criterion. This may occur, for example, if a user glances away and back from a UI component within a predefined window of time.

### Gesture Activation State Determination

According to one or more embodiments, additional considerations may be used in determining whether to activate an input action associated with a hand gesture. These various suppression rules or criteria may cause a user input action to be blocked, rejected, and/or cancelled. In some embodiments, various parameters may be used to determine whether a user action that would result in revealing a UI component should be blocked. Examples may include detecting that a hand has recently moved or whose position is otherwise unstable, or certain detected hand poses, such as if a hand is in a pinching pose, where contact is detected between two fingers, or if an index and thumb tips are close together, which may indicate that a user is holding an item. In these cases, the rejection reasons may prevent a user input component from being revealed which would otherwise be revealed based on the hand gesture state.

As another example, dismissal criteria may indicate parameters which cause a these are action to be blocked which would reveal or dismiss a UI component. Examples may include a determination that a hand has recently been in another gesture, such as a hover, touch, or pinch, determining that a hand is close to a headset or otherwise within a predefined proximity to a head position of the user, a determination that the hand is occluded by an object (which may indicate, for example, that the hand is occupied), determining that two hands are close together, determining that a hand was recently in a non-hand-anchored indirect pinch, or determining that the index finger has curled (which may indicate, for example, that a user is about to drop their hand). In these cases, the blocking criteria being satisfied may prevent a user input component from being revealed which would otherwise be revealed based on the hand gesture state.

As yet another example, rejection reasons may be used to block transition to a palm-flip state, and/or cancel the input action associated with the gesture. Examples may include determining that a wrist has recently moved, or that a hand is occluded by an object. In these cases, the dismissal reasons may block a transition to a palm-flip state, and/or may cancel the gesture, thereby requiring a palm-up hand gesture reset.

A gesture activation state may be determined based on the gesture detection state and suppression criteria. To that end, the gesture activation state may be considered an extension of the gesture detection state. FIG. 8 shows a state machine for activation and suppression of hand gestures, in accordance with one or more embodiments. In some embodiments, the candidate gesture activation states may include a palm-up state 802, a palm-flip state 806, and an invalid state 804, where the gesture is neither in a palm-up state or a palm-flip state. The gesture activation state is used to determine whether to allow or suppress a user input action associated with a hand gesture. Thus, the gesture activation state is used to activate user input actions associated with the corresponding state. Accordingly, in some embodiments, the gesture activation state machine 800 may begin from a state determined from the gesture detection state machine 700 of FIG. 7.

According to one or more embodiments, the gesture activation state may transition from a palm-up state 802 to a palm-flip state 806 based on the gesture detection state determined to be in a palm-flip state, as shown at 825. Thus, in some embodiments, the suppression criteria may not be considered in transitioning from a palm-up state to a palm-flip state. Similarly, at 820, a palm-flip state 806 may transition to a palm-up state 802 based on the gesture activation state being a palm-up state. Said another way, transitions between the palm-up state and palm-flip state may be based on characteristics of the head and hand, such as the palm normal vector, the palm-to-head vector, and/or a head vector, without regard for suppression criteria (or, as described above with respect to gesture detection state machine 700 of FIG. 7, gaze information). Further, the transitions between palm up and palm flip may be based on the determined hand orientation state.

From a palm-flip state 806, the hand gesture state (for gesture activation state) may transition to an invalid state 804 based on gaze and hand pose information, as shown at 830. In some embodiments, the hand gesture state may transition from the palm-flip state 806 to an invalid state 804 if any dismissal reason is true or any rejection reason is true. As described above, dismissal reasons may indicate parameters which cause a these are action to be blocked which would reveal or dismiss a UI component. Rejection reasons may be used to block transition to a palm-flip state, and/or cancel the input action associated with the gesture. Similarly, the hand gesture state may transition from the palm-up state 802 to an invalid state 804 if any dismissal reason is true, as shown at 815.

From the invalid state 804, the gesture activation state may transition to the palm-up state 802 if the gesture detection state is a palm-up state and if no suppression reasons are true, as shown at 810. For example, if from the invalid state 804, where the hand has been upside down or otherwise pointing downward, a gesture detection state is determined to be in a palm-up state, the hand gesture state will only transition to the palm-up state 802 (as a gesture activation state) if no suppression criteria block, reject, or otherwise override the transition.

According to one or more embodiments, the gesture activation state machine 800 may not support a transition from an invalid state 804 to a palm-flip state 806. However, in some embodiments, the gesture activation state machine 800 may optionally support a transition from invalid state 804 to palm-flip state 806. For example, as shown at 835, the gesture activation state may transition from invalid state 804 to palm-flip state 806 if the hand gesture state is determined to be the palm-flip state, and no rejection reasons are true. This may occur, for example, if the palm-up state was blocked because of a blocking reasons, such as a moving hand.

Once the gesture activation state is determined, an action may be invoked corresponding to the gesture activation state. For example, if the gesture activation state is palm-up state 802, then a first user input action may be performed, whereas if the gesture activation state is the palm-flip state 806, a second user input action may be performed. Further, if the gesture activation state is invalid state 804, then no action may be performed and, optionally, input actions may be cancelled, in accordance with the corresponding suppression reasons.

### Example Electronic Device and Related Components

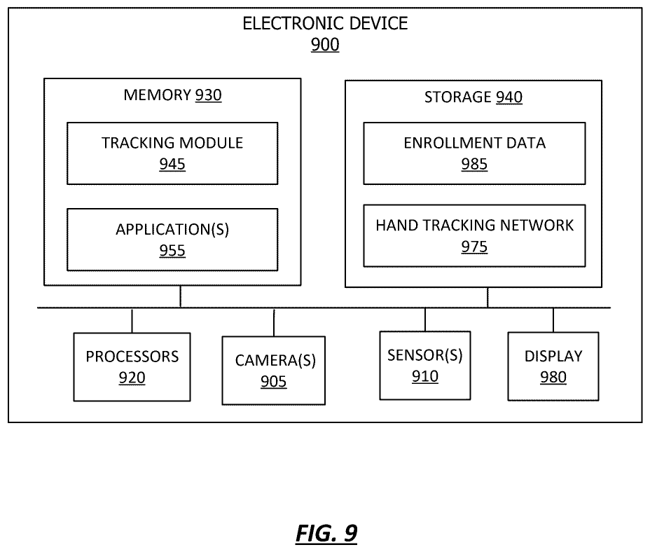

Referring to FIG. 9, a simplified block diagram of an electronic device 900 is depicted. Electronic device 900 may be part of a multifunctional device, such as a mobile phone, tablet computer, personal digital assistant, portable music/video player, wearable device, head-mounted systems, projection-based systems, base station, laptop computer, desktop computer, network device, or any other electronic systems such as those described herein. For example, electronic device 115 of FIG. 1A, or electronic device 215 of FIG. 2A may be examples of electronic device 900. Electronic device 900 may include one or more additional devices within which the various functionality may be contained or across which the various functionality may be distributed, such as server devices, base stations, accessory devices, etc. Illustrative networks include, but are not limited to, a local network such as a universal serial bus (USB) network, an organization's local area network, and a wide area network such as the Internet. According to one or more embodiments, electronic device 900 is utilized to interact with a user interface of an application 955. According to one or more embodiments, application(s) 955 may include one or more editing applications, or applications otherwise providing editing functionality such as markup. It should be understood that the various components and functionality within electronic device 900 may be differently distributed across the modules or components, or even across additional devices.

Electronic Device 900 may include one or more processors 920, such as a central processing unit (CPU) or graphics processing unit (GPU). Electronic device 900 may also include a memory 930. Memory 930 may include one or more different types of memory, which may be used for performing device functions in conjunction with processor(s) 920. For example, memory 930 may include cache, ROM, RAM, or any kind of transitory or non-transitory computer readable medium capable of storing computer readable code. Memory 930 may store various programming modules for execution by processor(s) 920, including tracking module 945, and other various applications 955. Electronic device 900 may also include storage 940. Storage 940 may include one more non-transitory computer-readable mediums including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Storage 940 may be utilized to store various data and structures which may be utilized for storing data related to hand tracking and UI preferences. Storage 940 may be configured to store hand tracking network 975, and other data used for determining hand motion, such as enrollment data 985, according to one or more embodiments. Electronic device may additionally include a network interface from which the electronic device 900 can communicate across a network.

Electronic device 900 may also include one or more cameras 905 or other sensors 910, such as a depth sensor, from which depth of a scene may be determined. In one or more embodiments, each of the one or more cameras 905 may be a traditional RGB camera or a depth camera. Further, cameras 905 may include a stereo camera or other multicamera system. In addition, electronic device 900 may include other sensors which may collect sensor data for tracking user movements, such as a depth camera, infrared sensors, or orientation sensors, such as one or more gyroscopes, accelerometers, and the like.

According to one or more embodiments, memory 930 may include one or more modules that comprise computer-readable code executable by the processor(s) 920 to perform functions. Memory 930 may include, for example, tracking module 945, and one or more application(s) 955. Tracking module 945 may be used to track locations of hands, arms, joints, and other indicators of user pose and/or motion in a physical environment. Tracking module 945 may use sensor data, such as data from cameras 905 and/or sensors 910. In some embodiments, tracking module 945 may track user movements to determine whether to trigger user input from a detected input gesture. In some embodiments described herein, the tracking module 945 may be configured to determine a hand input state, hand gesture state, and/or gesture activation state based on hand tracking data, head pose information, gaze information, or the like. Electronic device 900 may optionally include a display 980 or other device by a user interface (UI) may be displayed or presented for interaction by a user. The UI may be associated with one or more of the application(s) 955, for example. Display 980 may be an opaque display, or may be semitransparent or transparent, such as a pass-through display or a see-through display. Display 980 may incorporate LEDs, OLEDs, a digital light projector, liquid crystal on silicon, or the like.

Although electronic device 900 is depicted as comprising the numerous components described above, in one or more embodiments, the various components may be distributed across multiple devices. Accordingly, although certain calls and transmissions are described herein with respect to the particular systems as depicted, in one or more embodiments, the various calls and transmissions may be made differently, or may be differently directed based on the differently distributed functionality. Further, additional components may be used, some combination of the functionality of any of the components may be combined.

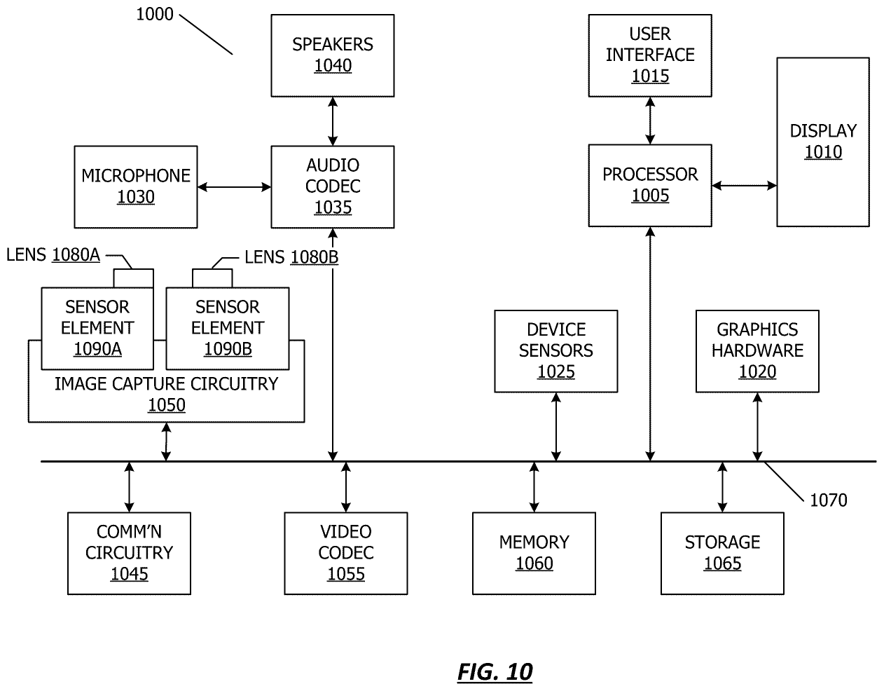

Referring now to FIG. 10, a simplified functional block diagram of illustrative multifunction electronic device 1000 is shown according to one embodiment. Each of electronic devices may be a multifunctional electronic device or may have some or all of the described components of a multifunctional electronic device described herein. Multifunction electronic device 1000 may include processor 1005, display 1010, user interface 1015, graphics hardware 1020, device sensors 1025 (e.g., proximity sensor/ambient light sensor, accelerometer and/or gyroscope), microphone 1030, audio codec(s) 1035, speaker(s) 1040, communications circuitry 1045, digital image capture circuitry 1050 (e.g., including camera system), video codec(s) 1055 (e.g., in support of digital image capture unit), memory 1060, storage device 1065, and communications bus 1070. Multifunction electronic device 1000 may be, for example, a digital camera or a personal electronic device such as a personal digital assistant (PDA), personal music player, mobile telephone, or a tablet computer.

Processor 1005 may execute instructions necessary to carry out or control the operation of many functions performed by device 1000 (e.g., such as the generation and/or processing of images as disclosed herein). Processor 1005 may, for instance, drive display 1010 and receive user input from user interface 1015. User interface 1015 may allow a user to interact with device 1000. For example, user interface 1015 can take a variety of forms, such as a button, keypad, dial, click wheel, keyboard, display screen, touch screen, gaze, and/or gestures. Processor 1005 may also, for example, be a system-on-chip such as those found in mobile devices and include a dedicated GPU. Processor 1005 may be based on reduced instruction-set computer (RISC) or complex instruction-set computer (CISC) architectures or any other suitable architecture and may include one or more processing cores. Graphics hardware 1020 may be special purpose computational hardware for processing graphics and/or assisting processor 1005 to process graphics information. In one embodiment, graphics hardware 1020 may include a programmable GPU.

Image capture circuitry 1050 may include two (or more) lens assemblies 1080A and 1080B, where each lens assembly may have a separate focal length. For example, lens assembly 1080A may have a short focal length relative to the focal length of lens assembly 1080B. Each lens assembly may have a separate associated sensor element 1090. Alternatively, two or more lens assemblies may share a common sensor element. Image capture circuitry 1050 may capture still and/or video images. Output from image capture circuitry 1050 may be processed by video codec(s) 1055 and/or processor 1005 and/or graphics hardware 1020, and/or a dedicated image processing unit or pipeline incorporated within circuitry 1050. Images so captured may be stored in memory 1060 and/or storage 1065.

Sensor and camera circuitry 1050 may capture still and video images that may be processed in accordance with this disclosure, at least in part, by video codec(s) 1055 and/or processor 1005 and/or graphics hardware 1020, and/or a dedicated image processing unit incorporated within circuitry 1050. Images captured may be stored in memory 1060 and/or storage 1065. Memory 1060 may include one or more different types of media used by processor 1005 and graphics hardware 1020 to perform device functions. For example, memory 1060 may include memory cache, read-only memory (ROM), and/or random-access memory (RAM). Storage 1065 may store media (e.g., audio, image, and video files), computer program instructions or software, preference information, device profile information, and any other suitable data. Storage 1065 may include one more non-transitory computer-readable storage mediums including, for example, magnetic disks (fixed, floppy, and removable) and tape, optical media such as CD-ROMs and DVDs, and semiconductor memory devices such as EPROM and EEPROM. Memory 1060 and storage 1065 may be used to tangibly retain computer program instructions, or code organized into one or more modules and written in any desired computer programming language. When executed by, for example, processor 1005 such computer program code may implement one or more of the methods described herein.

Various processes defined herein consider the option of obtaining and utilizing a user's identifying information. For example, such personal information may be utilized in order to track a user's pose and/or motion. However, to the extent such personal information is collected, such information should be obtained with the user's informed consent, and the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well established and in compliance with or above governmental/industry standards. Moreover, these parties will not distribute, sell, or otherwise share such information outside of any reasonable and legitimate purposes.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at city level rather than at an address level), controlling how data is stored (e.g., aggregating data across users), and/or other methods.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 3-6A and 7-8 or the arrangement of elements shown in FIGS. 1-2, 6B, and 9-10 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
determining geometric characteristics of a hand relative to a head of a user performing a gesture;
determining a gaze vector for the user;
determining a hand gesture state from a plurality of candidate hand gesture states based on the gaze vector and the geometric characteristics of the hand relative to the head of the user; and
in response to a determination that the hand gesture state corresponds to an input gesture, invoking an action corresponding to the input gesture.

2. The method of claim 1, wherein determining geometric characteristic of a hand relative to a head of a user comprises:
obtaining hand tracking data of the hand performing the gesture; and
obtaining a head vector for the user.

3. The method of claim 1, wherein the candidate hand gesture state comprise a palm-up state, a palm-flip state, and an invalid state.

4. The method of claim 1, wherein determining the hand gesture state comprises:
determining a hand orientation state from a plurality of candidate hand orientation states based on the geometric characteristics of the hand relative to the head; and
determining the hand gesture state based on the hand orientation state and the gaze vector.

5. The method of claim 4, wherein the hand orientation state is determined using a hand orientation state machine based on one or more of a group consisting of: 1) a palm-up-to-head angle indicating a relative position of a palm of the user toward a head of the user, 2) a palm-forward-to-head-y angle indicating a pointing direction of the palm of the user relative to the head of the user, and 3) a palm-up-to-head-y angle indicating a relative position of the palm toward an upward direction.

6. The method of claim 4, wherein the hand gesture state is determined using a gesture detection state machine and based on one or more of a group consisting of: 1) the hand gesture state; and 2) a determination of whether a gaze criterion is satisfied.

7. The method of claim 6, wherein determining whether the gaze criterion is satisfied comprises:
determining whether a target of the gaze vector is within a threshold distance of at least one of the hand, a controller, and a user input component.

8. The method of claim 4, further comprising:
obtaining controller tracking data; and
determining a controller orientation based on the controller tracking data, wherein determining the hand gesture state comprises:
determining a hand orientation state from a plurality of candidate hand orientation states based on the geometric characteristics of the controller orientation relative to the head; and
determining the hand gesture state based on the controller orientation state and the gaze vector.

9. A non-transitory computer readable medium comprising computer readable code executable by one or more processors to:
determine geometric characteristics of a hand relative to a head of a user performing a gesture;
determine a gaze vector for the user;
determine a hand gesture state from a plurality of candidate hand gesture states based on the gaze vector and the geometric characteristics of the hand relative to the head of the user; and
in response to a determination that the hand gesture state corresponds to an input gesture, invoke an action corresponding to the input gesture.

10. The non-transitory computer readable medium of claim 9, wherein the computer readable code to determine geometric characteristic of a hand relative to a head of a user comprises computer readable code to:
obtain hand tracking data of the hand performing the gesture; and
obtain a head vector for the user.

11. The non-transitory computer readable medium of claim 9, wherein the computer readable code to determine geometric characteristic of a hand relative to a head of a user comprises computer readable code to:
obtain controller tracking data of a controller held by the hand; and
obtain a head vector for the user.

12. The non-transitory computer readable medium of claim 9, wherein the candidate hand gesture states comprise a palm-up state, a palm-flip state, and an invalid state.

13. The non-transitory computer readable medium of claim 9, wherein the computer readable code to determine the hand gesture state comprises computer readable code to:
determine a hand orientation state from a plurality of candidate hand orientation states based on the geometric characteristics of the hand relative to the head; and
determine the hand gesture state based on the hand orientation state and the gaze vector.

14. The non-transitory computer readable medium of claim 13, wherein the hand orientation state is determined using a hand orientation state machine based on one or more of a group consisting of: 1) a palm-up-to-head angle indicating a relative position of a palm of the user toward a head of the user, 2) a palm-forward-to-head-y angle indicating a pointing direction of the palm of the user relative to the head of the user, and 3) a palm-up-to-head-y angle indicating a relative position of the palm toward an upward direction.

15. The non-transitory computer readable medium of claim 13, wherein the hand gesture state is determined using a gesture detection state machine and based on one or more of a group consisting of: 1) the hand gesture state; and 2) a determination of whether a gaze criterion is satisfied.

16. The non-transitory computer readable medium of claim 15, wherein the computer readable code to determine whether the gaze criterion is satisfied comprises computer readable code to:
determine whether a target of the gaze vector is within a threshold distance of at least one of the hand, a controller, and a user input component.

17. The non-transitory computer readable medium of claim 9, wherein the computer readable code to invoke an action corresponding to the input gesture further comprises computer readable code to:
determine a gesture activation state based on the hand gesture state and one or more suppression criteria.

18. A system comprising:
one or more processors; and
one or more computer readable media comprising computer readable code executable by the one or more processors to:
determine geometric characteristics of a hand relative to a head of a user performing a gesture;
determine a gaze vector for the user;
determine a hand gesture state from a plurality of candidate hand gesture states based on the gaze vector and the geometric characteristics of the hand relative to the head of the user; and
in response to a determination that the hand gesture state corresponds to an input gesture, invoke an action corresponding to the input gesture.

19. The system of claim 18, wherein the computer readable code to determine the hand gesture state comprises computer readable code to:
determine a hand orientation state from a plurality of candidate hand orientation states based on the geometric characteristics of the hand relative to the head; and
determine the hand gesture state based on the hand orientation state and the gaze vector.

20. The system of claim 18, wherein the computer readable code to invoke an action corresponding to the input gesture further comprises computer readable code to:
determine a gesture activation state based on the hand gesture state and one or more suppression criteria.
